(19) United States
(12) Patent Application Publication
(10) Pub. No.: US 2026/0272040 A1
(43) Pub. Date: Sep. 17, 2026

(54) IMPROVED YOUTH ACCESS PREVENTION FOR AEROSOL-GENERATING DEVICES

(71) Applicant: Philip Morris Products S.A., Neuchatel (CH)

(72) Inventors: Andrew James MCLAUCHLAN, Poliez-Le-Grand (CH); Nicolas GUEVARA, Chavannes-près-Renens (CH); Karl BAUMGARTNER, Renens (CH)

(73) Assignee: Philip Morris Products S.A., Neuchatel (CH)

(21) Appl. No.: 19/167,022

(22) PCT Filed: Feb. 29, 2024
(86) PCT No.: PCT/EP2024/055196

§ 371 Date: Sep. 19, 2025

(30) Foreign Application Priority Data
Mar. 21, 2023 (EP) 23163305

(51) Int. Cl. A24F 40/53; A24F 40/51; A24F 40/65; A24F 40/95

(52) U.S. Cl. CPC A24F 40/53; A24F 40/51; A24F 40/65; A24F 40/95

(57) ABSTRACT

An aerosol-generating device is provided, including: control circuitry including a controller configured to operate the aerosol-generating device in either one of a locked state, in which generation of aerosol by the aerosol-generating device is prohibited, and an unlocked state, in which generation of aerosol by the aerosol-generating device is allowed; and a light sensor operably coupled to the controller, the light sensor being configured to receive a series of light signals, the series of light signals being provided as a video, and the controller being further configured to transition the aerosol-generating device from the locked state into the unlocked state based on the series of light signals.

The present disclosure relates to an aerosol-generating device, a companion device configured to charge an aerosol-generating device with electrical energy, a computing device configured to provide an unlocking instruction to one of an aerosol-generating device and a companion device and a server device configured to provide unlocking data for one of an aerosol-generating device and a companion device. The present disclosure also relates to a system for youth access prevention for an aerosol-generating device, a computer implemented method for youth access prevention for an aerosol-generating device and a use of an LED comprised by an aerosol-generating device or a companion device.

Aerosol-generating devices are typically designed as handheld devices that can be used by a user for consuming or experiencing, for instance in one or more usage sessions, aerosol generated from an aerosol-generating substrate or an aerosol-generating article, for example by heating. The aerosol-generating devices the present disclosure pertains to are commonly referred to as heated tobacco products (HTP), heat-not-burn devices, electronic cigarettes and/or vaporisers.

Exemplary aerosol-generating substrates can comprise solid substrate material, such as tobacco material or tobacco cast leaves (TCL) material. The substrate material can, for example, be assembled, often with other elements or components, to form a substantially stick-shaped aerosol-generating article. Such a stick or aerosol-generating article can be configured in shape and size to be inserted at least partially into the aerosol-generating device. The aerosol-generating device may comprise a heating element or heater device for heating the aerosol-generating article and/or the aerosol-generating substrate. The heating element or heater device may be part of the aerosol-generating article and/or the aerosol-generating device. Alternatively or additionally, aerosol-generating substrates can comprise one or more liquids and/or solids, which can, for example, be supplied to the aerosol-generating device in the form of a cartridge or container. Corresponding exemplary aerosol-generating articles can, for example, comprise a cartridge containing or fillable with the liquid and/or solid substrate, which can be vaporized during aerosol consumption by the user based on heating the substrate and/or liquid. Usually, such cartridge or container can be coupled to, attached to or at least partially inserted into the aerosol-generating device. Alternatively, the cartridge may be fixedly mounted to the aerosol-generating device and refilled by inserting liquid and/or solid into the cartridge. The aerosol generated from the aerosol-generating substrate or article may comprise or include one or more of nicotine, aroma, sugar, moisturising agent, preservative, flavouring, for example cocoa, liquorice, menthol and lactic acid or other additives.

For generating the aerosol during use or consumption, heat can be supplied by a heating element, heater device or heat source to heat at least a portion or part of the aerosol-generating substrate. The heating element, heater device or heat source can be arranged in the handheld device or a handheld part of the aerosol-generating device. Alternatively or additionally, at least a part of or the entire heating element or heater device or heat source can be fixedly associated with or arranged within an aerosol-generating article, for instance in the form of a stick or cartridge, which can be attached to and/or powered by the handheld device or handheld part of the aerosol-generating device.

Exemplary heating elements or heater devices can be based on one or more of resistive heating, inductive heating and microwave heating using electrical energy supplied via, drawn from or stored in battery of the aerosol-generating device. As used herein, a battery of the aerosol-generating device can generally refer to an energy storage of the aerosol-generating device configured to store electrical energy. Accordingly, the term energy storage can include one or more batteries, one or more capacitors, one or more accumulators or other types of energy storage. Also, any reference to a battery herein can include a plurality of batteries.

Typically, aerosol-generating devices comprise an energy storage, for example a battery, providing the electrical energy needed to operate the aerosol-generating device and especially for heating the aerosol-generating substrate and/or article, for example to generate aerosol in one or more usage sessions using one or more aerosol-generating articles. The battery may, for example, be a lithium-ion battery.

As used herein, a usage session may refer to a period of time, during which a user may use the device to generate, consume, experience or inhale aerosol using the aerosol-generating device. Therein, a usage session may be finite. In other words, a usage session may have a start, an end and a duration. The duration of the usage session as measured by time may be influenced by use during the usage session. The duration of the usage session may have a maximum duration determined by a maximum time from the start of the usage session. The duration of the usage session may be less than the maximum time if one or more monitored parameters reaches a predetermined threshold before the maximum time from the start of the usage session. By way of example, the one or more monitored parameters may comprise one or more of: i) a cumulative puff count of a series of puffs drawn by a user since the start of the usage session, and ii) a cumulative volume of aerosol evolved from the aerosol-forming substrate since the start of the usage session.

In certain jurisdictions around the globe, there may exist legislature limiting the use of aerosol-generating devices as described herein to users above a certain age threshold, for example 18 years of age. For example, it may be prohibited to provide access to aerosol-generating devices to users below an age threshold. Therefore, aerosol-generating devices may comprise youth access prevention (YAP) systems. Such systems may require a user to undergo an age verification test before being able to use the aerosol-generating device. Such aerosol-generating devices may therefore be in a locked state when produced or sold. A YAP system may require the user to connect the locked aerosol-generating device to a smartphone via a data connection, for example Bluetooth or Bluetooth Low Energy (BLE). The smartphone can then be used to conduct the age verification test, for example by connection of the smartphone to an internet server providing the age verification test. If the age verification test is passed, the aerosol-generating device is unlocked and the user may use it to produce and consume aerosol.

One problem in known YAP systems may be that a device with the capability of establishing a data connection, for example a BLE connection, with the aerosol-generating device is necessary. The aerosol-generating device may also be more expensive because it too may need to be capable of establishing this connection. Additionally, the data connections may not be as reliable as necessary, possibly leading to a failure of unlocking the aerosol-generating device despite the user being of legal age and having passed the age verification test. For example, for BLE connections, consumer tests have shown failure rates in unlocking procedures of up to approximately 15%. This may reduce the quality of a user's experience and may induce user dissatisfaction.

It may therefore be desirable to provide for an improved YAP system for aerosol-generating devices. For example, it may be desirable to provide an easy to use and reliable system without the need for complex hardware. It may also be desirable to provide a system that is inexpensive.

These advantages may be achieved by the features described herein.

According to an aspect of the present invention, there is provided an aerosol-generating device, comprising: control circuitry comprising a controller configured to operate the aerosol-generating device in either one of a locked state, in which generation of aerosol by the aerosol-generating device is prohibited, and an unlocked state, in which generation of aerosol by the aerosol-generating device is allowed, and a light sensor operably coupled to the controller, wherein the light sensor is configured to receive a series of light signals, and wherein the controller is configured to transition the aerosol-generating device from the locked state into the unlocked state based on the series of light signals.

In the locked state of the aerosol-generating device, the generation of aerosol may be prohibited even when production of aerosol is demanded by the user, for example by inputting command signals to the aerosol-generating device, for example by pressing a button. The locked state may be implemented, for example, by disabling the heater or heating element or other device configured to produce aerosol from the aerosol-generating substrate or article. This may be achieved by a software installed on the aerosol-generating device and for example being executed by the controller. This software may, for example, be part of a firmware of the aerosol-generating device. In the locked state, the software may therefore prevent the use or activation of the heater or heating element or other device for the production of aerosol from the aerosol-generating substrate or article.

Conversely, in the unlocked state of the aerosol-generating device, the generation of aerosol may be allowed. The heater or heating element or other device configured to produce aerosol from the aerosol-generating substrate or article may therefore be enabled in the unlocked state. This may also be achieved by the software executed by the controller, for example the firmware. A user may therefore be provided with aerosol when the user inputs a command signal to the aerosol-generating device, for example by pressing a button.

In short, in the locked state of the aerosol-generating device, no aerosol may be generated, whereas aerosol may be generated in the unlocked state of the aerosol-generating device. Originally, the aerosol-generating device may be in the locked state, e.g., provided and/or sold to a user in the locked state. The aerosol-generating device may be produced in or put into the locked state by the manufacturer of the aerosol-generating device. Every factory-new aerosol-generating device may therefore be in the locked state.

To be able to use the aerosol-generating device, a user therefore has to unlock the aerosol-generating device by transitioning the aerosol-generating device from the locked state into the unlocked state. To implement the function of a YAP system, it may be provided that an aerosol-generating device may only be unlocked when it has been ensured that the user is of legal age. Therefore, the aerosol-generating device may need to be able to receive a signal signifying that an age verification has been passed by the user and that the aerosol-generating device may transition from the locked state to the unlocked state.

According to the present disclosure, this function may be implemented by the light sensor. The light sensor may be configured to detect changes in lighting conditions of the light sensor. For example, the light sensor may be configured to detect and/or distinguish between periods of time in which more light is present in the immediate surrounding of the light sensor and periods of time in which there is less light present in the immediate surrounding of the light sensor. In other words, the light sensor may be configured to detect and/or distinguish between bright and dark surroundings, for example periods of time of different illuminance of the light sensor. The illuminance of the light sensor may be the total luminous flux incident on the light sensor, per unit area. The illuminance of the light sensor may be measured in the SI-unit lux. Essentially, the light sensor may be configured to detect and/or distinguish between brighter and darker periods. In this way, different brightness or illuminance levels may be associated with different numerical values. This may then be used to encode a series of numbers in a series of light signals. For example, brighter and darker periods may be used to represent a different value each so that a series of light signals may be used to encode a signal, for example a binary signal, a light frequency modulated signal, and/or a light intensity modulated signal. The signal itself, for example the binary signal, may then be used to encode an arbitrary string of characters, for example numbers, letters or other symbols.

The series of light signals may therefore be a sequence or succession of periods of time of different or the same light levels or illuminance at the light sensor. In this way, the series of light levels received by the light sensor may convey the information to the aerosol-generating device that the user has passed the age verification test and that the aerosol-generating device may be transitioned from the locked state into the unlocked state. This information may be processed by the controller of the aerosol-generating device, for example through the software or firmware running on the aerosol-generating device, and may lead to unlocking of the aerosol-generating device. Receipt of the correct series of light signals may be the only way of unlocking the aerosol-generating device. By only providing a user of legal age with the correct series of light signals or with the means of providing the correct series of light signals to the light sensor and/or the aerosol-generating device, a YAP system may be implemented in the aerosol-generating device.

The series of light signals may comprise or encode an unlock signal. The controller may be configured to translate the series of light signals into the unlock signal. The unlock signal may be a command or control signal causing the controller to transition the aerosol-generating device from the locked state to the unlocked state. In this case, the receipt of the unlock signal by the controller directly leads to unlocking of the aerosol-generating device. The unlock signal may be the same signal for more than one aerosol-generating device, which may be useful for users operating more than one aerosol-generating device in parallel. Alternatively, the series of light signals may comprise or encode an unlock code. The controller may be configured to translate the series of light signals into the unlock code. The unlock code may be unique for the aerosol-generating device. The unlock code may therefore only work for one single aerosol-generating device, providing the system with heightened security.

The aerosol-generating device may be provided with or comprise a device identifier. The device identifier may be a unique identification of the aerosol-generating device. It may, for example, comprise a string of numbers and/or letters or other symbols. The device identifier may, for example, be a Codentify or a manufacturing information block (MIB) or similar. The controller may be configured to check whether or not the unlock code provided through the series of light signals is the correct unlock code for the device identifier of the aerosol-generating device. The controller may be configured to only unlock the aerosol-generating device if the unlock code is the correct one for the device identifier. In other words, the controller may be configured to transition the aerosol-generating device from the locked state into the unlocked state upon determining that the unlock code is associated with and/or matches the device identifier of the aerosol-generating device. In cases in which the unlock code is not associated with and/or does not match the device identifier of the aerosol-generating device, the controller is configured to keep the aerosol-generating device in the locked state.

The device identifier and/or the unlock code may be stored at the aerosol-generating device. For this, the aerosol-generating device may comprise a memory or data storage in which the device identifier and/or the unlock code may be stored. For example, a pair of a device identifier and an unlock code may be produced during production of the aerosol-generating device. The device identifier may be stored at the aerosol-generating device in a way that it is readily accessible by a user, for example by arranging the device identifier on the outside of the device and/or by reproducing the device identifier on packaging and/or documentation delivered with the aerosol-generating device. The device identifier may for example be reproduced as an optically readable code, for example a barcode or QR-code to make the device identifier easily accessible by a user using a computing device with a camera like a smart phone or similar. The unlock code, on the other hand, may be stored in an internal memory of the aerosol-generating device so as to be accessible for the controller of the aerosol-generating device but inaccessible from the outside, for example by the user. In this way, a user may retrieve an unlock code matching the device identifier (as explained in more detail below) and provide it to the aerosol-generating device by the series of light signals. The controller may then check whether the unlock code matches the unlock code in its internal memory and, if the unlock codes match, unlock the aerosol-generating device. Alternatively, the unlock code may be derivable from the device identifier (as explained in more detail below). In this case, it may be sufficient that the device identifier is stored in the memory of the aerosol-generating device. The controller can then check whether or not the received unlock code matches the device identifier by deriving the unlock code from the device identifier and comparing the derived unlock code with the received unlock code. In this case as well, the aerosol-generating device may only be unlocked when the unlock codes match.

It may be desirable to ensure that an unlocked aerosol-generating device is not used or at least not indefinitely used by a user below the legal age threshold. This may happen, for example, when an unlocked aerosol-generating device is sold on a second-hand basis. The aerosol-generating device may therefore be configured to re-lock itself after a predetermined period of time or after a predetermined number of uses, for example usage sessions, provided. There may also be a command signal, which, when input by a user, re-locks the aerosol-generating device. In other words, the controller may be configured to transition the aerosol-generating device from the unlocked state into the locked state upon determining that a predetermined period of time has elapsed or that a predetermined number of uses of the aerosol-generating device has been reached or that a specific control signal is received. The predetermined period of time may, for example, be one month, three months, six months, twelve months, or longer. The predetermined number of uses may, for example, be 10 uses, 50 uses, 100 uses, 250 uses, 500 uses, 750 uses, 1000 uses, 1500 uses, 2000 uses, 5000 uses, or more. These values are merely exemplary and any other period of time and/or number of uses may be used.

The aerosol-generating device may then be re-unlocked in accordance with the disclosure described herein. However, it may be provided that the aerosol-generating device may only be re-unlocked by an unlock signal or unlock code that is different from the unlock signal or unlock code previously used to unlock the aerosol-generating device. In other words, the controller may be configured to transition the aerosol-generating device from the locked state into the unlocked state only if an unlock code that is associated with or matches the device identifier, and preferably differs from the previous unlock code, is received. To implement this, there may be a plurality of different unlock codes stored in the memory of the aerosol-generating device. Alternatively, different unlock codes may be derivable from the device identifier in combination with a serial number associated with the number of re-unlocks. The aerosol-generating device may also be configured to provide a random number which can then be used along with the device identifier to provide a unique unlock code for this pair of random number and device identifier. By changing the unlock code, misuse of the aerosol-generating device by a user not of legal age may be prevented.

The aerosol-generating device may further comprise an aerosol-generating article and/or substrate. The aerosol-generating device may be, preferably in the unlocked state, configured to generate aerosol from the aerosol-generating article and/or substrate. The aerosol-generating article and/or substrate may be configured as described above. The aerosol-generating article and/or substrate may be at least partially inserted into the aerosol-generating device.

The aerosol-generating device may further comprise an energy storage for storing electrical energy. The electrical energy stored in the energy storage may, for example, be used to power the controller and/or the heater or heating element configured to heat the aerosol-generating article or substrate. The energy storage may be non-rechargeable, for example a non-rechargeable battery. Such non-rechargeable energy storages may, for example, be used in one-way or disposable aerosol-generating devices. The present disclosure may be especially useful in such devices, because it may be easier to use than conventional systems and has very low cost and may therefore be implemented in cheap devices as well. Simultaneously, it may be easier for underage users/users below the legal age to obtain disposable aerosol-generating devices, underlining the need for YAP.

According to a further aspect of the present invention, there is provided a companion device configured to charge an aerosol-generating device with electrical energy, comprising: control circuitry comprising a controller, a light sensor, and a communications arrangement, wherein the light sensor is configured to receive a series of light signals, and wherein the controller is configured to provide an unlocking instruction to the aerosol-generating device via the communications arrangement.

All of the features, functions and advantages described in this disclosure with respect to the aerosol-generating device are also applicable to the companion device and vice versa.

Companion devices may be configured to be electrically connected to the aerosol-generating device. For instance, companion devices may be configured to at least partially receive the aerosol-generating device in a cavity of the companion device. By at least partially inserting the aerosol-generating device into the companion device, the electrical connection between the companion device and the aerosol-generating device may be established. Through this electrical connection, the companion device may charge the aerosol-generating device with electrical energy. The companion device may therefore comprise an energy storage, for example a battery or a battery pack, which may have a capacity that is larger than the capacity of the energy storage of the aerosol-generating device itself. A companion device may therefore be used to store the aerosol-generating device between uses and simultaneously recharge the aerosol-generating device, in particular fully recharge the aerosol-generating device several times in a row before the companion device itself needs to be recharged.

The companion device may also comprise a communications arrangement configured to establish a data connection with the aerosol-generating device. This data connection may, for example, also be established through a physical connection to the aerosol-generating device that is in turn established when the aerosol-generating device is at least partially inserted into the companion device for recharging. The communications arrangement may also comprise a wireless communications device. In this case, the aerosol-generating device may also comprise a corresponding wireless communications device. The wireless communications device may be configured to establish a data connection between the companion device and the aerosol-generating device.

The companion device may, as an alternative to the aerosol-generating device or in addition to the aerosol-generating device, be configured to receive the series of light signals via a light sensor as described herein. If the companion device comprises the light sensor and is configured to receive the series of light signals, the light sensor of the aerosol-generating device may be dispensed with and vice versa. To implement unlocking of the aerosol-generating device when the correct series of light signals is received by the companion device, the controller of the companion device may be configured to send an unlocking instruction to the aerosol-generating device by the communications arrangement.

The unlocking instruction may comprise an unlock code or an unlock signal as described above. For instance, the controller may be configured to translate the series of light signals into an unlock code. The controller may then be configured to provide the unlock code to the aerosol-generating device via the communications arrangement. The aerosol-generating device may then proceed similar to the case in which the unlock code is extracted from the series of light signals by the controller of the aerosol-generating device itself. In other words, the aerosol-generating device may itself check whether or not the unlock code is the correct unlock code and matches either an unlock code stored in the aerosol-generating device or a device identifier of the aerosol-generating device as described above.

On the other hand, the companion device may also be configured to check whether or not the unlock code is the correct unlock code and matches either an unlock code stored in the aerosol-generating device or a device identifier of the aerosol-generating device. For this, the companion device may be configured to read the unlock code or the device identifier from the data storage or memory of the aerosol-generating device. The controller of the companion device may be configured to provide the unlocking instruction to the aerosol-generating device upon determining that the unlock code is associated with a device identifier of the aerosol-generating device or an unlock code that is stored in the aerosol-generating device. The unlocking instruction may comprise an unlock signal that directly leads to unlocking of the aerosol-generating device as described above.

It may also be provided that both the aerosol-generating device and the companion device are configured to check whether or not the unlock code is the correct unlock code and matches either an unlock code stored in the aerosol-generating device or a device identifier of the aerosol-generating device. In this case, this check may be performed twice as an additional security layer against misuse.

In any of the devices according to the present disclosure, the light sensor may be a light transceiver. The light sensor may therefore be configured to receive and to emit light. It may therefore be possible to use the light sensor as a light emitter in other operational situations of the aerosol-generating device or the companion device, further decreasing complexity and cost. The light sensor may, for example, be a light-emitting diode (LED), preferably a low current or low power LED. Low current or low power LED may be highly efficient LED that produce light at very low currents, for example around 2 mA. These LED may be used as light transceivers, are sensitive to light signals and may therefore be suitable as the light sensors according to the present disclosure. Also, such LED may already be in use on aerosol-generating devices and companion devices. It may therefore be possible to implement the features of the present disclosure in devices without structurally redesigning them. To implement the features of the present disclosure, it may be enough to change the software or firmware of the respective devices, which may even enable retrofitting of existing devices. Additionally, the present disclosure may be implemented without necessitating additional components on the devices, improving cost-efficiency. The light transceiver may be transitioned from a light emitting to a light receiving mode by a command signal of the user, for example through an input device, like a button, of the aerosol-generating device or the companion device.

Consequently, it may be provided that the light sensor is configured as a signaling device to provide information about operation of the device to a user. When used as a signaling device, the light sensor may be used as a light emitter. The light sensor may therefore convey information to the user by shining or blinking, for example blinking in a predetermined pattern. The information conveyed to the user may, for example, pertain to an operational state of the companion device or the aerosol-generating device. For instance, the information may pertain to whether the aerosol-generating device is in the locked state or the unlocked state. The information may also pertain to a state of charge of the energy storage of one or both of the devices.

The light sensor may be or may comprise a photodiode and/or a camera instead of or in addition to an LED light sensor.

According to a further aspect of the present invention, there is provided a computing device configured to provide an unlocking instruction to one of an aerosol-generating device and a companion device configured to charge an aerosol-generating device with electrical energy, comprising: a light emitter, preferably a display, and a data connection to a server device, wherein the computing device is configured to receive unlocking data from the server device, wherein the computing device is configured to provide the unlocking instruction by emitting the unlocking data as a series of light signals via the light emitter.

All of the features, functions and advantages described in this disclosure with respect to the aerosol-generating device and/or the companion device are also applicable to the computing device and vice versa.

The light emitter of the computing device may be any kind of light emitter suitable for emitting and/or displaying visual information, pictures or videos, for example a display or display device. When a display is used, the display may, for example, be a screen, a flat screen, or a touchscreen. The light emitter may be configured to emit data visually and may especially be configured to emit the series of light signals. The light emitter may be configured to emit data using a light signal in the invisible spectrum, e.g., infra-red signals. The light emitter may comprise a flashlight of the computing device.

The data connection to the server device may be any kind of data connection, either physical or wireless. The data connection to the server may be configured as telecommunications, for example a mobile internet connection. The data connection may, for example, be based on any of the standards developed and/or maintained by the 3rd Generation Partnership Project (3GPP), for example GSM, UMTS, LTE, 5G or any other suitable telecommunications means.

Further, the computing device may be configured to receive the device identifier from the user, for example via an input device. The input device may, for example, be a touchscreen or a keyboard or any other suitable means for inputting information into the computing device. The computing device may be configured to transfer the device identifier to the server device, for example via the data connection.

The computing device may be configured to enable the user of the aerosol-generating device to perform or complete an age verification test on the server. The computing device may be configured to receive age verification information from the user, for example via the input device, and transfer this information to the server device via the data connection. If the age verification test is passed, the computing device may be configured to receive unlocking data from the server device and provide the companion device or the aerosol-generating device with this unlocking data or an unlocking instruction by providing the series of light signals by the light emitter, for example on the display. The series of light signals presented via the light emitter may therefore comprise or encode an unlocking instruction and/or the unlocking data received from the server.

For example, the series of light signals may encode or be derived from the unlock code. The unlock code may therefore be comprised in the unlocking instruction and/or the unlocking data. Upon receipt of the series of light signals, the companion device and/or the aerosol-generating device may therefore proceed as described above.

The computing device may be configured to check whether or not the unlock code is the correct unlock code and matches or is correct for either an unlock code stored in the aerosol-generating device or a device identifier of the aerosol-generating device. For this, the computing device may be configured to read the unlock code or the device identifier from the data storage or memory of the aerosol-generating device and/or the companion device. Thus, the computing device may be “offline” (e.g., not connected to the internet and/or not connected to a further computing device) when it is used to unlock the aerosol-generating device. The controller of the computing device may be configured to provide the unlocking instruction to the aerosol-generating device or the companion device upon determining that the unlock code is associated with a device identifier of the aerosol-generating device or an unlock code that is stored in the aerosol-generating device. The unlocking instruction may comprise an unlock signal that directly leads to unlocking of the aerosol-generating device as described above.

The computing device may be one of a smartphone, a tablet computer, a personal computer, a smart watch, an on-board computer, for example in a car or a work machine, and a smart television. The computing device may be any kind of device able to receive age verification information from the user and transmit this information to the server device, then receive unlocking data from the server device and provide the series of light signals via a light emitter. The existing display of the computing device may be used as light emitter. This type of display may already be present on a plurality of different devices, may be sufficient to provide the series of light signals. The user therefore may not need a specific computing device to be able to unlock the aerosol-generating device. Instead, the user may use any of a plurality of computing devices without any specialized or specific hardware.

According to a further aspect of the present invention, there is provided a server device configured to provide unlocking data for one of an aerosol-generating device and a companion device configured to charge an aerosol-generating device with electrical energy to a computing device, wherein the server device is configured to: perform an age verification test on a user of the aerosol-generating device through the computing device, provide the unlocking data to the computing device upon determining the age verification test has been passed, and provide the unlocking data as instructions for the computing device to emit a series of light signals.

The server device may, for example, be a web or internet server, for instance maintained by the manufacturer of the companion device and/or aerosol-generating device. The server device may be configured to receive age verification information about the user from the computing device. The server may be configured to use this age verification information to perform the age verification test. The server may be configured to only proceed in the case that the age verification test is successfully passed and to not proceed and display a message informing the user of the failure to pass the age verification test otherwise.

When the age verification test is successfully passed, the server may be configured to provide unlocking data for the aerosol-generating device to the computing device. The unlocking data may comprise an unlocking instruction, for example an unlock code or an unlock signal. The unlocking data may be provided to the computing device as instructions or other means for the computing device to emit the series of light signals as explained above.

It may be provided that the server device provides unlocking data that is specific for an aerosol-generating device. To achieve this, the server device may be configured to receive, from the computing device, a device identifier of the aerosol-generating device. The unlocking data may be associated with or may correspond to the device identifier of the aerosol-generating device. For example, the server device may comprise a data storage in which all the device identifiers of every aerosol-generating device produced and/or sold by the manufacturer are stored. The data storage of the server device may also comprise a specific unlock code for every device identifier. The server device may be configured to retrieve the specific unlock code for the aerosol-generating device from the data storage in accordance with the device identifier received from the computing device. Alternatively, it may also be provided to derive the unlock code from the device identifier, as will be further explained below. The series of light signals may be derived from the unlock code as described above.

The series of light signals may, for example, be provided as a video. In this case, for example, the unlocking data provided by the server to the computing device may be a video or video data. The series of light signals may be provided as a series of high-contrast images. The succession or sequence of the series of images may constitute the video or the video data. The images or the series of light signals may be provided as a series of monochrome images. For example, the series of light signals may comprise images of high brightness, for example images of white or near-white color, and images of low brightness, for example images of black or near-black color. As explained above, for implementing a binary encoding of the information to be transmitted, it may be enough that the series of light signals exclusively contains a plurality of renderings of two different images, for example a first image of high brightness or illuminance and a second image of low brightness or illuminance. One image used in the series of light signals may constitute one bit of information. The speed at which the images in the series of light signals follow upon each other may be configured so that the series of light signals contains 5 bits per second or 10 bits per second or 15 bits per second or 20 bits per second or 25 bits per second or 30 bits per second or 35 bits per second or 40 bits per second. In other words, the series of light signals may contain 5, 10, 15, 20, 25, 30, 35 or 40 images per second. In this way, the series of light signals may be used to encode at least one of the unlocking data, the unlocking instruction, the unlock code and the unlock signal.

In addition to at least one of the unlocking data, the unlocking instruction, the unlock code and the unlock signal, the series of light signals may also encode further information. For instance, at least one of a begin signature, an end signature, and an error checking number may be additionally encoded in the series of light signals. The begin signature and the end signature may be fixed strings of data that are the same for every series of light signals, regardless of the device identifier of the specific aerosol-generating device. They may therefore be used to ensure that the device receiving the series of light signals may automatically realize whether or not the full sequence in the series of light signals has been received or not. Also, in case the bit rate of the series of light signals may be different in each case, for example depending on the length of the specific unlock code used, the begin signature and the end signature may be used by the device receiving the series of light signals to detect the bit rate and therefore correctly interpret the part of the series of light signals encoding the relevant data. An error checking number may additionally be used to prevent or identify losses or inconsistencies during data transfer.

Generally, at least one of the unlocking data, the unlocking instruction, the unlock code and the unlock signal may be a random string or may be based on a random string, for example a random number. In this case, the random string may be stored both in the data storage of the aerosol-generating device and the server device so as to be able to correctly identify the correct string for a specific device identifier. Alternatively, at least one of the unlocking data, the unlocking instruction, the unlock code and the unlock signal may be derived from the device identifier of the aerosol-generating device. This may, for example, be achieved by an algorithm that deterministically derives a string from the device identifier that is different from the device identifier itself. For example, at least one of the unlocking data, the unlocking instruction, the unlock code and the unlock signal may be derived from the device identifier by one of hashing and encrypting the device identifier. Merely as an example, the device identifier may be hashed using keyed-hash message authentication code or hash-based message authentication code (HMAC) or encrypted using advanced encryption standard (AES), for example AES 128. In this case, the server device may not need to store any information about the aerosol-generating device. The server device may simply use the device identifier provided by the computing device and derive the unlocking data from this device identifier. Also the device or devices which check the validity of the received data encoded by the series of light signals may check the validity of the received data by deriving the correct data, for example the correct unlock code, from the device identifier of the aerosol-generating device. In this way, also the aerosol-generating device may not need to store for example the unlock code in addition to the device identifier.

According to a further aspect of the present invention, there is provided a system for youth access prevention (YAP) for an aerosol-generating device, the system comprising a server device, a computing device, and at least one of an aerosol-generating device and a companion device according the present disclosure.

All of the features, functions and advantages described in this disclosure with respect to the aerosol-generating device, the companion device, the computing device and/or the server device are also applicable to the system for YAP for an aerosol-generating device and vice versa.

In the case that the system comprises both the aerosol-generating device and the companion device, it may be sufficient that only one of these devices is configured as described in the present disclosure. For example, only one of these devices may comprise a light sensor to receive the series of light signals. On the other hand, it may also be provided that both the aerosol-generating device and the companion device are configured as described in the present disclosure, for example with both devices comprising a light sensor to receive the series of light signals. In this case, this redundancy may further simplify the process of unlocking the aerosol-generating device for the user.

According to a further aspect of the present invention, there is provided a computer implemented method for youth access prevention (YAP) for an aerosol-generating device, preferably an aerosol-generating device according to the present disclosure, the method comprising: performing, on a server device, an age verification test, retrieving, upon determining that the age verification test is passed, unlocking data, transferring the unlocking data to the aerosol-generating device or a companion device configured to charge the aerosol-generating device with electrical energy by emitting, on a computing device, a series of light signals encoding the unlocking data, receiving the series of light signals by a light sensor on the aerosol-generating device or the companion device, and unlocking the aerosol-generating device based on the received series of light signals.

All of the features, functions and advantages described in this disclosure with respect to the aerosol-generating device, the companion device, the computing device, the server device and/or the system for YAP for an aerosol-generating device are also applicable to the computer implemented method for YAP for an aerosol-generating device and vice versa.

The method may further comprise providing the aerosol-generating device with a device identifier, preferably a unique device identifier. As explained above, the device identifier may be arranged on or with the aerosol-generating device so as to be readily available for a user. The user may therefore input the device identifier into the computing device for transfer to the server device. The method may therefore further comprise transferring the device identifier to the server device via the computing device. The server device may be configured to provide unlocking data specific for the device identifier of the aerosol-generating device to the computing device.

Additionally, the method may comprise translating the series of light signals into an unlock code. This step may be performed on the aerosol-generating device and/or on the companion device. As described above, the unlock code may be associated with or derived from the device identifier. The method may therefore comprise unlocking the aerosol-generating device upon determining that the unlock code is associated with or derived from the device identifier.

According to a further aspect of the present invention, there is provided a use of an LED comprised by an aerosol-generating device or a companion device configured to charge an aerosol-generating device with electrical energy to receive an unlock code for unlocking the aerosol-generating device and allowing aerosol generation.

All of the features, functions and advantages described in this disclosure with respect to the aerosol-generating device, the companion device, the computing device, the server device, the system for YAP for an aerosol-generating device and/or the computer implemented method for YAP for an aerosol-generating device are also applicable to the use of an LED and vice versa.

Using an LED of the aerosol-generating device and/or companion device to receive a series of light signals encoding an unlock code for transitioning the aerosol-generating device from the locked state to the unlock state is a reliable and cost-effective way of implementing YAP in an aerosol-generating device.

The invention is defined in the claims. However, below there is provided a non-exhaustive list of non-limiting examples. Any one or more of the features of these examples may be combined with any one or more features of another example, embodiment, or aspect described herein.

Example 1. An aerosol-generating device, comprising:
control circuitry comprising a controller configured to operate the aerosol-generating device in either one of a locked state, in which generation of aerosol by the aerosol-generating device is prohibited, and an unlocked state, in which generation of aerosol by the aerosol-generating device is allowed, and
a light sensor operably coupled to the controller,
wherein the light sensor is configured to receive a series of light signals, and
wherein the controller is configured to transition the aerosol-generating device from the locked state into the unlocked state based on the series of light signals.

Example 2. The aerosol-generating device according to Example 1, wherein the controller is configured to translate the series of light signals into an unlock code.

Example 3. The aerosol-generating device according to the previous Example, wherein the controller is configured to transition the aerosol-generating device from the locked state into the unlocked state upon determining that the unlock code is associated with a device identifier of the aerosol-generating device.

Example 4. The aerosol-generating device according to Example 2, wherein the controller is configured to transition the aerosol-generating device from the locked state into the unlocked state upon determining that the unlock code matches or is correct for a device identifier of the aerosol-generating device.

Example 5. The aerosol-generating device according to any of Examples 3-4, wherein the device identifier and/or the unlock code is stored at the aerosol-generating device.

Example 6. The aerosol-generating device according to any of the previous Examples, wherein the controller is configured to transition the aerosol-generating device from the unlocked state into the locked state upon determining that a predetermined period of time has elapsed or that a predetermined number of uses of the aerosol-generating device has been reached or that a specific control signal is received.

Example 7. The aerosol-generating device according to the previous Example, wherein the controller is configured to transition the aerosol-generating device from the locked state into the unlocked state only if an unlock code that is associated with or is correct for or matches a device identifier, and preferably differs from the previous unlock code, is received.

Example 8. The aerosol-generating device according to any of the previous Examples, further comprising an aerosol-generating article or substrate.

Example 9. The aerosol-generating device according to the previous Example, wherein the aerosol-generating device is configured to generate aerosol from the aerosol-generating article or substrate.

Example 10. The aerosol-generating device according to any of the previous Examples, further comprising an energy storage for storing electrical energy, wherein the energy storage preferably is non-rechargeable, for example a non-rechargeable battery.

Example 11. A companion device configured to charge an aerosol-generating device with electrical energy, comprising:
control circuitry comprising a controller,
a light sensor, and
a communications arrangement,
wherein the light sensor is configured to receive a series of light signals, and
wherein the controller is configured to provide an unlocking instruction to the aerosol-generating device via the communications arrangement.

Example 12. The companion device according to the previous Example, wherein the controller is configured to translate the series of light signals into an unlock code.

Example 13. The companion device according to any of Examples 11-12, wherein the unlocking instruction comprises an unlock code or an unlock signal.

Example 14. The companion device according to any of Examples 12-13, wherein the controller is configured to provide the unlocking instruction to the aerosol-generating device upon determining that the unlock code is associated with a device identifier of the aerosol-generating device.

Example 15. The device according to any of the previous Examples, wherein the light sensor is a light transceiver.

Example 16. The device according to any of the previous Examples, wherein the light sensor is an LED, preferably a low current or low power LED.

Example 17. The device according to any of the previous Examples, wherein the light sensor is configured as a signalling device to provide information about an operation of the device to a user.

Example 18. A computing device configured to provide an unlocking instruction to one of an aerosol-generating device and a companion device configured to charge an aerosol-generating device with electrical energy, comprising:
a light emitter, preferably a display, and
a data connection to a server device,
wherein the computing device is configured to receive unlocking data from the server device,
wherein the computing device is configured to provide the unlocking instruction by emitting the unlocking data as a series of light signals via the light emitter.

Example 19. The computing device according to the previous Example, wherein the series of light signals is derived from an unlock code.

Example 20. The computing device according to any of the previous Examples 18-19, wherein the computing device is one of a smartphone, a tablet computer, a personal computer, a smart watch, an on-board computer and a smart television.

Example 21. A server device configured to provide unlocking data for one of an aerosol-generating device and a companion device configured to charge an aerosol-generating device with electrical energy to a computing device,
wherein the server device is configured to:
perform an age verification test on a user of the aerosol-generating device through the computing device,
provide the unlocking data to the computing device upon determining the age verification test has been passed, and
provide the unlocking data as instructions for the computing device to emit a series of light signals.

Example 22. The server device according to the previous Example, wherein the server device is configured to receive, from the computing device, a device identifier of the aerosol-generating device.

Example 23. The server device according to the previous Example, wherein the unlocking data is associated with the device identifier of the aerosol-generating device.

Example 24. The server device according to any one of Examples 21-23, wherein the unlocking data comprises an unlock code.

Example 25. The server device according to the previous Example, wherein the series of light signals is derived from the unlock code.

Example 26. The device according to any of the previous Examples, wherein the series of light signals is provided as a video.

Example 27. The device according to any of the previous Examples, wherein the series of light signals is provided as a series of high-contrast images.

Example 28. The device according to any of the previous Examples, wherein the series of light signals is provided as a series of monochrome images.

Example 29. The device according to any of the previous Examples, wherein the series of light signals encodes, in addition to an unlock code, at least one of a begin signature, an end signature, and an error checking number.

Example 30. The device according to any of the previous Examples 2-5, 7, 12-14, 19, 24-25 and 29, wherein the unlock code is derived from a device identifier of the aerosol-generating device.

Example 31. The device according to the previous Example, wherein the unlock code is derived from the device identifier by one of hashing and encrypting the device identifier.

Example 32. The device according to the previous Example, wherein the device identifier is hashed using HMAC or encrypted using AES.

Example 33. A system for youth access prevention for an aerosol-generating device, the system comprising a server device according to any one of Examples 21-32, a computing device according to any one of Examples 18-20 and 26-32, and at least one of an aerosol-generating device according to any one of Examples 1-10, 15-17 and 26-32 and a companion device according to any one of Examples 11-17 and 26-32.

Example 34. A computer implemented method for youth access prevention for an aerosol-generating device, preferably an aerosol-generating device according to any one of Examples 1-10, 15-17 and 26-32, the method comprising:
performing, on a server device, an age verification test,
retrieving, upon determining that the age verification test is passed, unlocking data,
transferring the unlocking data to the aerosol-generating device or a companion device configured to charge the aerosol-generating device with electrical energy by
emitting, on a computing device, a series of light signals encoding the unlocking data,
receiving the series of light signals by a light sensor on the aerosol-generating device or the companion device, and
unlocking the aerosol-generating device based on the received series of light signals.

Example 35. The method according to the previous Example, further comprising providing the aerosol-generating device with a device identifier.

Example 36. The method according to the previous Example, further comprising transferring the device identifier to the server device via the computing device.

Example 37. The method according to any one of Examples 34-36, further comprising translating the series of light signals into an unlock code.

Example 38. The method according to the previous Example, wherein the unlock code is associated with the device identifier.

Example 39. The method according to the previous Example, comprising unlocking the aerosol-generating device upon determining that the unlock code is associated with the device identifier.

Example 40. Use of an LED comprised by an aerosol-generating device or a companion device configured to charge an aerosol-generating device with electrical energy to receive an unlock code for unlocking the aerosol-generating device and allowing aerosol generation.

Examples will now be further described with reference to the figures in which:

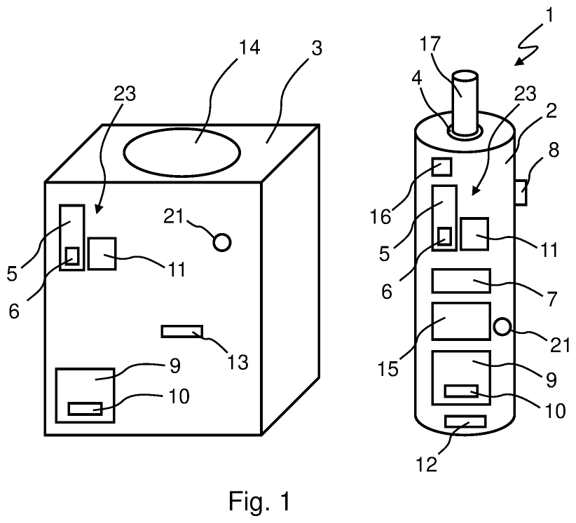

FIG. 1 shows an aerosol-generating device and a companion device;

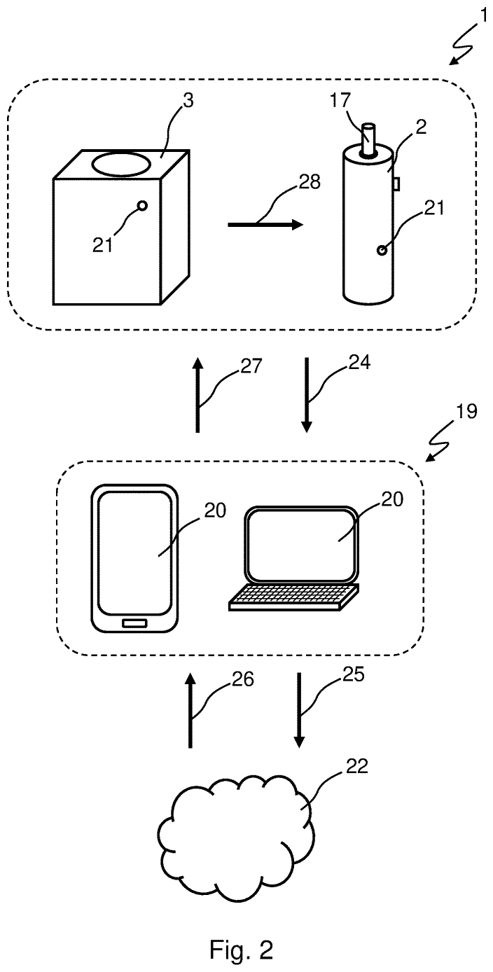

FIG. 2 shows a system for youth access prevention in an aerosol-generating device; and

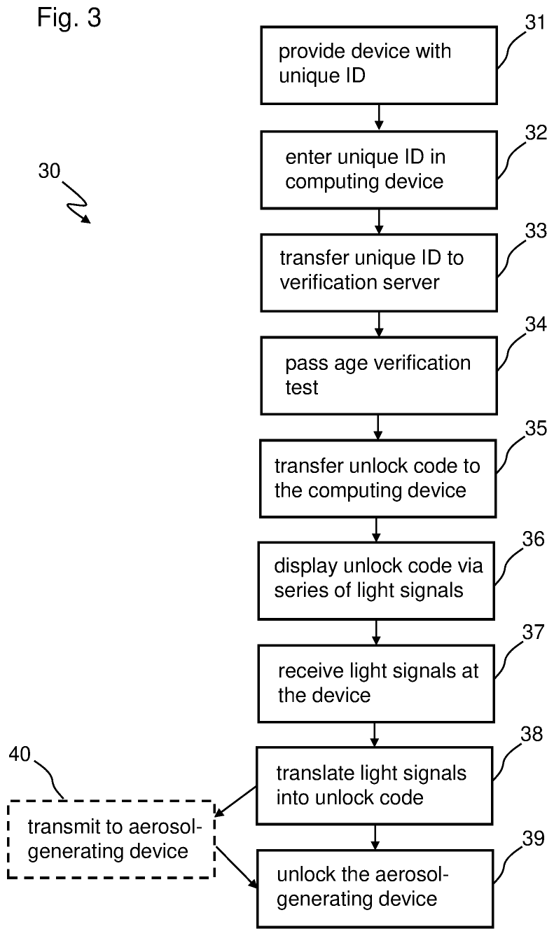

FIG. 3 shows a flowchart of a computer implemented method for youth access prevention in an aerosol-generating device.

The figures are schematic only and not to scale.

FIG. 1 shows an aerosol-generating system 1 for generating aerosol, for example for consumption by a user in one or more usage sessions. The system 1 may comprise an aerosol-generating device 2 for generating aerosol and a companion device 3 for at least partially receiving the aerosol-generating device 2. The companion device 3 may be a charging device for charging the aerosol-generating device 2 and/or an energy storage or battery thereof.

The aerosol-generating device 2 may comprise an insertion opening 4 for at least partially inserting an aerosol-generating article 17. The aerosol-generating article 17 may comprise an aerosol-forming substrate, such as a tobacco containing substrate, and/or a cartridge comprising a liquid.

The aerosol-generating device 2 may further include processing circuitry 23 or control circuitry 23 with at least one controller 5 and one or more processors 6. For generating the aerosol during use or consumption of the aerosol-generating article 17, the aerosol-generating device 2 may comprise at least one heating element 7 or heater device for applying heat to at least a portion of the aerosol-generating article 17. Instead of the heating element 7, an ultrasonic device (not shown) may also be used to generate aerosol from the aerosol-generating article 17. The processing circuitry 23 and/or the controller 5 may be configured to control actuation, activation and/or deactivation of at least one heating element 7 or ultrasonic device.

For powering the at least one heating element 7 with electrical power, the aerosol-generating device 2 may further comprise at least one energy storage 15, for example in the form of a battery, for storing electrical energy or power. The aerosol-generating device 2 may further comprise at least one electrical connector 12 for coupling to a corresponding at least one electrical connector 13 of the companion device 3 and/or an electrical connector of an external power supply (not shown), e.g., a USB charger. For example, when the aerosol-generating device 2 is at least partially inserted into the opening 14 of the companion device 3, the one or more electrical connectors 12 of the aerosol-generating device 2 may be coupled with the one or more electrical connectors 13 of the companion device 3 to charge the at least one energy storage 15 of the aerosol-generating device 2.

The aerosol-generating device 2 may further comprise a communications arrangement 9 or communication circuitry 9 with one or more communications interfaces 10 for communicatively coupling the aerosol-generating device 2 with the companion device 3, for example, via an Internet connection, a wireless LAN connection, a WiFi connection, a Bluetooth connection, a mobile phone network, a 3G/4G/5G connection, an edge connection, an LTE connection, a BUS connection, a wireless connection, a wired connection, a radio connection, a near field connection, and/or an IoT connection.

The aerosol-generating device 2 may further comprise a data storage 11 for storing information, program code or data. One or more sensors 16 may be arranged on, at or in the aerosol-generating device 2 to collect data. One or more of the sensors 16 may for example be temperature sensors, strain sensors, accelerometers or any other suitable sensors.

The aerosol-generating device 2 may further comprise user interface components, for example comprising an input element or input device 8, for example in the form of a pushbutton. The input device 8 may be used as a power button to activate or deactivate the heating element 7 or ultrasonic device for aerosol generation thereby to activate or deactivate the aerosol-generating device 2. Upon activation of the aerosol-generating device 2, the heating element 7 may be activated and heat may be applied to at least a part of the aerosol-generating article 17, such that aerosol can be generated for consumption by the user, for example in a usage session. The aerosol generating device 2 and/or the companion device 3 may each comprise a user interface comprising one or more output elements, such as an LED 21, for outputting a signal to a user.

The LED 21 may be a light transceiver and may be configured as a light sensor according to the present disclosure. The user may input a command signal, for example via the input device 8, which causes the controller 5 to put the LED 21 into a light sensor mode in which the LED 21 acts as a light sensor for receiving the series of light signals. The LED 21 may therefore be configured to receive a series of light signals and provide controller 5 with signals representing the information comprised or encoded in the series of light signals. For example, the series of light signals may encode data in a binary code of bright and dark. The controller 5 may therefore receive signals representing this encoded data and enabling the controller 5 to derive the encoded data from the signals.

FIG. 2 shows a system for youth access prevention in an aerosol-generating device 2. The system may comprise a server device 22, for example an internet or web server, a computing device 19, for example a smart phone or a personal computer, and at least one of the devices of the aerosol-generating system 1, for example an aerosol-generating device 2 and/or a companion device 3. As indicated by arrow 24, a user wishing to unlock the aerosol-generating device 2, i.e. wishing to transition the aerosol-generating device 2 from the locked state into the unlocked state, may input the unique device identifier of the aerosol-generating device 2 into the computing device 19. For example, the user may read the device identifier, which may be arranged on the outside of the aerosol-generating device 2 or its packaging or documentation and may type the device identifier into the computing device 19. Alternatively, if the computing device 19 comprises a camera, for example like a smart phone, the user may scan an optically readable code, like a QR-code or a barcode, containing the device identifier and provided on the aerosol-generating device 2 or its packaging or documentation.

As indicated by arrow 25, the device identifier may then be transmitted from the computing device 19 to the server device 22. Along with the device identifier, the user may input age verification information into the computing device 19 which may then also be transmitted to the server device 22. The data connection between the computing device 19 and the server device 22 may be established through an internet connection, preferably a mobile internet connection, of the computing device 19. The server device 22 may then perform an age verification test on the age verification information provided by the user. The age verification test may be a legal age user (LAU)-test to determine whether or not the user is allowed to operate the aerosol-generating device 2 in their jurisdiction. The server device 22 may only proceed in the case that the age verification test is successfully passed and when it is therefore determined that the user is indeed allowed to operate the aerosol-generating device 2.

When the age verification test is successfully passed, the server device 22 may retrieve an unlock code that is associated with or derived from the device identifier. For example, the server device 22 may have access to a data storage in which a specific unlock code for each device identifier is stored. Retrieving the unlock code may therefore comprise looking up the device identifier in the data storage and reading the corresponding unlock code. Alternatively, the unlock code may be derived from the device identifier by the server device 22 by an algorithm. For example, the unlock code may be produced from the device identifier by hashing or encrypting the device identifier. This may also lead to a unique unlock code for each unique device identifier.

As indicated by arrow 26, after the age verification test is successfully passed, the server device 22 may transmit unlocking data to the computing device 19. The unlocking data may comprise or encode the unlock code. The unlocking data may be in the form of instructions for the computing device 19 to display the series of light signals, wherein the series of light signals also comprises or encodes the unlock code. For example, the unlocking data provided by the server device may be in the form of a video. The video may comprise a series of bright/dark-contrasted images encoding the data. The computing device 19 may receive the unlocking data from the server device 22, for example via the same data connection used for transmitting the device identifier and the age verification information from the computing device 19 to the server device 22.

The computing device 19 may comprise a light emitter, for example a display 20 configured to present visual information, images or videos. The computing device 19 may be configured to present the unlocking data received from the server device 22 on the display 20 as a series of light signals. For example, the computing device 19 may play the video constituting the unlocking data on the display 20. As indicated by arrow 27, by presenting the series of light signals, the computing device 19 may provide an unlocking instruction to the companion device 3 and/or the aerosol-generating device 2.

The computing device 19 may comprise a software, for example an app, which may check whether the unlocking data received from the server device 22 and particularly the unlock code is correct for the device identifier of the aerosol-generating device 2. In the case that the unlock code is correct for the device identifier, the unlocking instruction provided by the computing device 19 may comprise an unlock signal that directly leads to the unlocking of the aerosol-generating device 2.

However, it is not necessary for the computing device 19 to have such a software because the checking of the validity of the unlocking data received from the server device 22 may also be performed on the level of the aerosol-generating system 1. In this case, no special software or app may be needed on the computing device 19 and all of the steps necessary to be performed on the computing device 19 may, for example, be performed using a web browser or similar software which may already be installed on the computing device 19. The unlocking instruction provided by the computing device 19 may therefore comprise the unlock code.

The unlocking instruction provided by the computing device 19 comprising the unlock signal or the unlock code may be received by the companion device 3 and/or the aerosol-generating device 2. This may be achieved by the LED 21 of the companion device 3 and/or the aerosol-generating device 2 acting as light sensor and receiving the series of lights signals emitted from the display 20 of the computing device 19. For this transmission to be as accurate as possible, it may be helpful if the user places the LED 21 of the companion device 3 and/or the aerosol-generating device 2 in close proximity or next to the display 20 of the computing device 19. Through the series of light signals, the unlocking instruction is transferred from the computing device 19 to the companion device 3 and/or the aerosol-generating device 2.

When the unlocking instruction is received by the companion device 3, the companion device 3 may in turn transfer the unlocking instruction to the aerosol-generating device 2 via the communications arrangement 9. This is indicated by the arrow 28. Depending on whether or not the companion device 3 checks the validity of the unlock code, the unlocking instruction transferred from the companion device 3 to the aerosol-generating device 2 may comprise the unlock signal (especially in case the companion device 3 checks the validity of the unlock code) and/or the unlock code (especially in case the companion device 3 does not check the validity of the unlock code). For example, the companion device 3 may be configured to read the device identifier and/or the unlock code stored in the data storage 11 of the aerosol-generating device 2. The companion device 3 may be configured to check whether the unlock code received in the unlocking instruction from the computing device 19 matches or is correct for the unlock code and/or the device identifier stored in the aerosol-generating device 2. If the unlock code in the unlocking instruction received from the computing device 19 is valid, the companion device 3 may be configured to transmit an unlock signal as unlocking instruction to the aerosol-generating device 2 which then directly leads to the unlocking of the aerosol-generating device 2. On the other hand, the companion device 3 may simply transmit the unlocking instruction as received through the series of light signals from the computing device 19 to the aerosol-generating device 2 via the communications arrangement 9 without checking the validity of the unlock code. In this case, the unlocking instruction transmitted by the companion device 3 to the aerosol-generating device 2 comprises the unlock code.

The aerosol-generating device 2 may receive an unlocking instruction either from the computing device 19 via the series of light signals as indicated by arrow 27 or from the companion device 3 via the communications arrangement 9 as indicated by arrow 28. The unlocking instruction received by the aerosol-generating device 2 may comprise the unlock code and/or the unlock signal. In the case that the unlocking instruction comprises the unlock signal, the validity of the unlock code may already have been checked by the companion device 3 and/or the computing device 19. Therefore, the aerosol-generating device 2 may immediately unlock upon receipt of the unlock signal. In other words, the controller 5 of the aerosol-generating device 2 may transition the aerosol-generating device 2 from the locked state into the unlocked state upon receipt of the unlock signal. In the case that the unlocking instruction comprises the unlock code, the aerosol-generating device 2 may check the validity of the unlock code itself. For this, the controller 5 may check whether the unlock code matches or is correct for an unlock code stored in the data storage 11 of the aerosol-generating device 2. Alternatively, if the unlock code is derived from the device identifier by an algorithm, the controller 5 may execute the algorithm on the device identifier and check whether the unlock code received from the companion device 3 or the computing device 19 matches the result of the algorithm. When the validity of the unlock code received is verified, the aerosol-generating device 2 may transition from the locked state to the unlocked state. Unlocking of the aerosol-generating device 2 may therefore be tied to successfully passing an age verification or LAU-test.

FIG. 3 shows a flowchart of the computer implemented method 30 for youth access prevention for an aerosol-generating device 2. The method 30 may start with step 31, in which the aerosol-generating device 2 may be provided with a unique device identifier. The aerosol-generating device 2 may also be provided with a separate unique unlock code. However, this may not be necessary in cases where the unlock code is derivable from the device identifier.

In step 32, the device identifier is entered into the computing device 19 by a user. The user may accomplish this by typing the device identifier into the computing device 19 or by scanning the device identifier with the computing device 19. The user may also enter age verification information into the computing device 19.

In step 33, the device identifier and the age verification information may be transmitted from the computing device 19 to the server device 22, for example via an internet connection.

In step 34, the user may have to pass an age verification or LAU-test performed by the server device 22 on the age verification information transmitted by the computing device 19. The method 30 stops in case the age verification or LAU-test is not passed by the user. Conversely, the method 30 only proceeds to step 35 if the age verification or LAU-test is successfully passed and it has been determined that the user is of legal age.

In step 35, the server device 22 transfers an unlock code specific for the aerosol-generating device 2 to the computing device 19. The unlock code may be part of or be encoded in unlocking data transmitted from the server device 22 to the computing device 19. In case that the unlock code may not be derivable from the device identifier and, for example, is a random string, the server device 22 may retrieve the specific unlock code from a database in which all unlock codes for all device identifiers are stored. In the case that the unlock code is derivable from the device identifier via an algorithm, the server device 22 may produce the unlock code from the device identifier via the algorithm.

In step 36, the unlock code and/or the unlocking data may be displayed by the computing device 19 on a display 20 of the computing device 19 via the series of light signals. In this step, the computing device 19 may transmit an unlocking instruction to the companion device 3 and/or the aerosol-generating device 2 via the series of light signals. The computing device 19 may not need any bi-directional data connection to the companion device 3 or the aerosol-generating device 2. It may be sufficient for the computing device 19 to present the series of light signals on the display 20.

In step 37, the series of light signals may be received at the companion device 3 and/or the aerosol-generating device 2. Specifically, the series of light signals is received by the LED 21 of the companion device 3 and/or the aerosol-generating device 2 acting as a light sensor. In the case that the series of light signals comprising or encoding the unlocking instruction is received at the companion device 3, the companion device 3 may translate the series of light signals into the unlock code or the unlock signal (see step 38). The companion device 3 may then check the validity of the unlock code by comparing the unlock code to an unlock code stored in the data storage 11 of the aerosol-generating device 2 or by deriving the unlock code from the device identifier of the aerosol-generating device 2 by an algorithm and comparing this derived unlock code to the unlock code received from the computing device 19. If it is determined that the unlock code received from the computing device 19 is valid, the companion device 3 may transmit the unlock code and/or the unlock signal to the aerosol-generating device 2 in step 40. In cases in which the companion device 3 only receives an unlock signal from the computing device 19, the companion device 3 may directly transmit the unlock signal to the aerosol-generating device 2. The communication between the computing device 3 and the aerosol-generating device 2 may be established through the communications arrangement 9.

In the case that the series of light signals comprising or encoding the unlocking instruction is received at the aerosol-generating device 2 either from the companion device 3 or the computing device 19, the aerosol-generating device 2 may translate the series of light signals into the unlock code or the unlock signal (see step 38). The aerosol-generating device 2 may then check the validity of the unlock code by comparing the unlock code to an unlock code stored in the data storage 11 of the aerosol-generating device 2 or by deriving the unlock code from the device identifier of the aerosol-generating device 2 by an algorithm and comparing this derived unlock code to the unlock code received from the computing device 19. If it is determined that the unlock code received from the computing device 19 is valid, the controller 5 of the aerosol-generating device 2 may transition the aerosol-generating device 2 from the locked state into the unlocked state, thereby unlocking the aerosol-generating device 2 to allow aerosol generation. In cases in which the aerosol-generating device 2 only receives an unlock signal from the computing device 19 or the companion device 3, the controller 5 may directly proceed to unlock the aerosol-generating device 2.

In the following, there is given an illustrative example which is only meant to illustrate the present disclosure and not limit it in any way. For example, the series of light signals may contain 10 images per second, representing 10 bits per second. The unlocking instruction may contain the unlock code as a hashed value of the device identifier. The resulting string containing the unlock code may, for example, be 32 bytes long, which would result in a very secure unlock code. This string may then be 256 bits long. The unlocking instruction may contain additional information, such as a begin signature, and end signature or an error checking number as explained above. With this additional data, the total length of the unlocking instruction may, for example, be about 500 bits long, meaning a series of 500 light signals or images or frames of a video. The time needed to read this series of light signals or this video by the LED 21, using a 10 images per second series of light signals, for example a 10 frames per second video speed, would then be 50 seconds, which is an acceptable duration.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10 % of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
control circuitry comprising a controller configured to operate the aerosol-generating device in either one of a locked state, in which generation of aerosol by the aerosol-generating device is prohibited, and an unlocked state, in which generation of aerosol by the aerosol-generating device is allowed; and
a light sensor operably coupled to the controller,
wherein the light sensor is configured to receive a series of light signals,
wherein the series of light signals is provided as a video, and
wherein the controller is further configured to transition the aerosol-generating device from the locked state into the unlocked state based on the series of light signals.

17. The aerosol-generating device according to claim 16, wherein the controller is further configured to translate the series of light signals into an unlock code.

18. The aerosol-generating device according to claim 17, wherein the controller is further configured to transition the aerosol-generating device from the locked state into the unlocked state upon determining that the unlock code is associated with a device identifier of the aerosol-generating device.

19. The aerosol-generating device according to claim 16, wherein the controller is further configured to transition the aerosol-generating device from the unlocked state into the locked state upon determining that a predetermined period of time has elapsed or that a predetermined number of uses of the aerosol-generating device has been reached or that a specific control signal is received.

20. The aerosol-generating device according to claim 16, wherein the controller is further configured to transition the aerosol-generating device from the locked state into the unlocked state only if an unlock code that is associated with or is correct for or matches a device identifier is received.

21. The aerosol-generating device according to claim 16, wherein the controller is further configured to transition the aerosol-generating device from the locked state into the unlocked state only if an unlock code that is associated with or is correct for or matches a device identifier, and differs from the previous unlock code, is received.

22. The aerosol-generating device according to claim 16, further comprising an aerosol-generating article or substrate.

23. The aerosol-generating device according to claim 16, further comprising an energy storage for storing electrical energy.

24. The aerosol-generating device according to claim 23, wherein the energy storage is a non-rechargeable battery.

25. A companion device configured to charge an aerosol-generating device with electrical energy, comprising:
control circuitry comprising a controller;
a light sensor; and
a communications arrangement,
wherein the light sensor is configured to receive a series of light signals,
wherein the series of light signals is provided as a video, and
wherein the controller is further configured to provide an unlocking instruction to the aerosol-generating device via the communications arrangement.

26. The aerosol-generating device according to claim 16, wherein the light sensor is a light transceiver.

27. The aerosol-generating device according to claim 16, wherein the light sensor is an LED.

28. A computing device configured to provide an unlocking instruction to one of an aerosol-generating device and a companion device configured to charge an aerosol-generating device with electrical energy, comprising:
a light emitter; and
a data connection to a server device,
wherein the computing device is further configured to receive unlocking data from the server device,
wherein the computing device is further configured to provide the unlocking instruction by emitting the unlocking data as a series of light signals via the light emitter, and
wherein the series of light signals is provided as a video.

29. The aerosol-generating device according to claim 16, wherein the series of light signals is provided as a series of high-contrast images and/or a series of monochrome images.

30. A computer-implemented method for youth access prevention for an aerosol-generating device according to claim 16, the computer-implemented method comprising:
performing, on a server device, an age verification test;
retrieving, upon determining that the age verification test is passed, unlocking data; and
transferring the unlocking data to the aerosol-generating device or a companion device configured to charge the aerosol-generating device with electrical energy by:
emitting, on a computing device, a series of light signals encoding the unlocking data,
receiving the series of light signals by a light sensor on the aerosol-generating device or the companion device, and
unlocking the aerosol-generating device based on the received series of light signals, wherein the series of light signals is provided as a video.
